(19) United States
(12) Patent Application Publication
(10) Pub. No.: US 2012/0191313 A1
(43) Pub. Date: Jul. 26, 2012

(54) IN-VEHICLE SYSTEM

(75) Inventor: Takayuki Miyahara, Kariya-shi (JP)

(73) Assignee: DENSO CORPORATION, Kariya-city (JP)

(21) Appl. No.: 13/353,427

(22) Filed: Jan. 19, 2012

(30) Foreign Application Priority Data
Jan. 21, 2011 (JP) 2011-011255

(51) Int. Cl. B60T 7/12; B60W 10/04; B60W 10/184; B60W 30/08

(52) U.S. Cl. 701/70

(57) ABSTRACT

In an in-vehicle system, no brake force is generated in a brake control device of a motor vehicle within a predetermined period of time counted from a time when incorrect operation of an accelerator pedal of the motor vehicle is occurred in order to allow the motor vehicle to slightly move in a forward direction. After a predetermined period of time is elapsed, the brake force is increased from zero in order to stop the forward movement of the motor vehicle.

### CROSS-REFERENCE TO RELATED APPLICATION

This application is related to and claims priority from Japanese Patent Application No. 2011-011255 filed on Jan. 21, 2011, the contents of which are hereby incorporated by reference.

### BACKGROUND OF THE INVENTION

1. Field of the Invention

The present invention relates to in-vehicle systems for detecting driver's unintended behavior or incorrect operation of the accelerator pedal of a motor vehicle, and for controlling the movement of the motor vehicle stably.

2. Description of the Related Art

There are serious problems regarding the driving of motor vehicles such as unintended or unexpected operation of the accelerator pedal of a motor vehicle, for example, deeply depressing the accelerator pedal many time, when the driver of the motor vehicle intends to depress the brake pedal of the motor vehicle. In order to avoid and solve the problems, various measures and methods have been proposed.

For example, a conventional patent document 1 (Japanese patent laid open publication No. H11-278092), proposes a conventional technique to detect an incorrect operation caused by the driver of a motor vehicle on the basis of a sudden unintended depressing the accelerator pedal of the motor vehicle. The conventional technique then instructs a brake device to inhibit a forward movement of the motor vehicle.

However, the conventional technique, for example, disclosed in the conventional patent document 1 involves the following problem which is caused when a control device inhibits the forward movement of the motor vehicle on detecting an occurrence of an incorrect operation of the accelerator pedal.

For example, when one of the wheels of a motor vehicle is dropped in a street gutter, or when the motor vehicle is stopped in a dangerous area such as within the railroad crossing gates of a railroad crossing, the driver of a motor vehicle panics and strongly and deeply depresses the accelerator pedal many time in order to escape from the railroad crossing. In this case, because the control device detects the unintended operation by the driver to the accelerator pedal and inhibits the forward movement of the motor vehicle, it is necessary for the motor vehicle to have a resetting switch in order to release the inhibition of the forward movement of the motor vehicle in order to escape from the railroad. However, because the driver of the motor vehicle does not usually use such a releasing switch, the driver often forgets the presence and the position of the releasing switch when an inevitable accident occurs. This is a problem.

### SUMMARY

It is therefore desired to provide an in-vehicle system capable of controlling the movement of a motor vehicle on the basis of a detection result for the driver of the motor vehicle to cause unintended or unexpected operation or incorrect operation of the accelerator pedal such as deeply or strongly depressing the accelerator pedal many time, and capable of allowing the motor vehicle to escape from a dangerous area to a safe area, namely, of escaping the oncoming train, without pushing on or using any releasing switch when the in-vehicle system detects a driver's incorrect operation of the accelerator pedal.

An exemplary embodiment provides an in-vehicle system having an incorrect operation judgment means and vehicle control means. The incorrect operation judgment means detects an occurrence of incorrect operation by the driver of a motor vehicle to depress an accelerator pedal of the motor vehicle at least one or many time. The vehicle control means controls a brake force on movement of the motor vehicle on the basis of the judgment result of the incorrect operation judgment means when a driver's incorrect operation is occurred. For example, the driver suddenly depresses many time the accelerator pedal of the motor vehicle. The vehicle control means allows a forward movement of the motor vehicle during a predetermined period T1 of time. The predetermined period T1 of time is determined in advance according to a predetermined movement distance after the incorrect operation judgment means detects an occurrence of incorrect operation in which the driver strongly or deeply depresses the accelerator pedal of the motor vehicle many time. The vehicle control means increases a brake force to be generated in a brake control device of the motor vehicle in order to stop the forward movement of the motor vehicle after the predetermined period T1 of time is elapsed.

### BRIEF DESCRIPTION OF THE DRAWINGS

A preferred, non-limiting embodiment of the present invention will be described by way of example with reference to the accompanying drawings, in which:

FIG. 1 is a view showing a structure of an in-vehicle system according to a first exemplary embodiment of the present invention;

FIG. 2 is a flow chart showing a process executed by a collision reduction and escaping control device in the in-vehicle system shown in FIG. 1;

FIG. 3 is a flow chart showing a process executed by an accelerator pedal incorrect operation detection device for detecting an incorrect operation of an accelerator pedal in the in-vehicle system shown in FIG. 1;

FIG. 4 is a flow chart showing a process executed by a conflict control device in the in-vehicle system shown in FIG. 1;

FIG. 5A to FIG. 5D are schematic views showing a first exemplary case under the control of the in-vehicle system shown in FIG. 1;

FIG. 6 is a flow chart showing a procedure of a second exemplary case under the control of the in-vehicle system shown in FIG. 1;

FIG. 7A to FIG. 7G are schematic views showing the second exemplary case under the control of the in-vehicle system shown in FIG. 1;

FIG. 8A to FIG. 8C are views showing a change of a brake pressure and a ratio of opening of a throttle valve when the driver of a motor vehicle causes an unintended operation to depress the accelerator pedal of the motor vehicle;

FIG. 9A to FIG. 9F are views showing a comparative example;

FIG. 10 is a flow chart showing a procedure of the in-vehicle system according to another exemplary embodiment of the present invention;

FIG. 11A to FIG. 11H are views showing another exemplary case executed by the in-vehicle system according to another exemplary embodiment of the present invention; and

FIG. 12 is a view showing another structure of the in-vehicle system according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

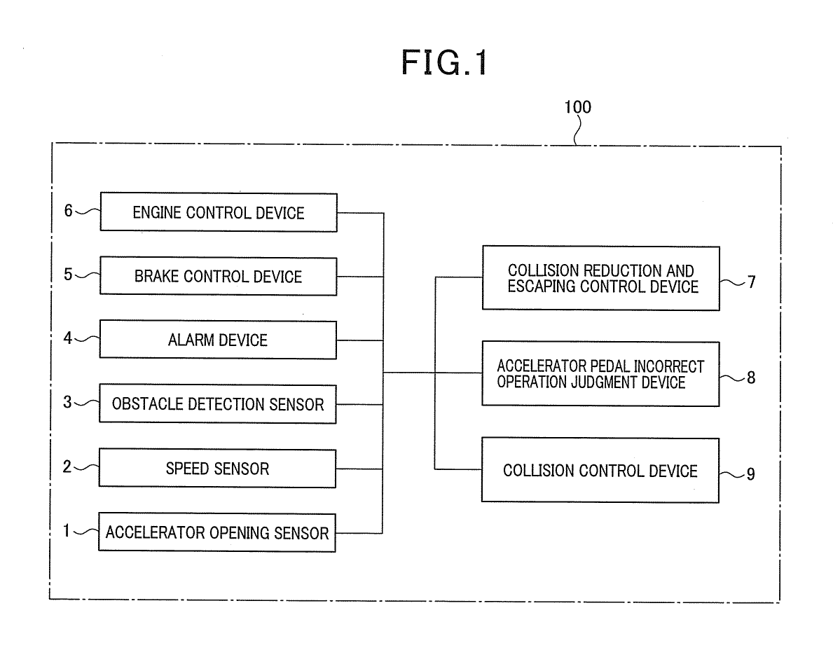

A description will be given of an in-vehicle system 100 according to a first exemplary embodiment of the present invention with reference to FIG. 1 to FIG. 9A-FIG. 9F.

FIG. 1 is a view showing a structure of the in-vehicle system 100 according to the first exemplary embodiment of the present invention. The in-vehicle system 100 is mounted to a motor vehicle. As shown in FIG. 1, the in-vehicle system 100 is equipped with an accelerator opening sensor 1, a speed sensor 2, an obstacle detection sensor 3, and electric control units (ECU) and various other sensors and devices. That is, the in-vehicle system 100 has an alarm device 4, a brake control device 5, the ECU acting as an engine control device 6, an ECU acting as a collision reduction and acting as an escaping control device 7, the ECU acting as an accelerator pedal incorrect operation judgment device 8, the ECU acting as a conflict control device 9, etc. These devices 1 to 9 communicate together through a communication network in a motor vehicle, for example, through an in-vehicle local area network (in-vehicle LAN).

The accelerator opening sensor 1 detects an amount of depressing (or an angle of depressing) an accelerator pedal by the driver of the motor vehicle. The speed sensor 2 detects a drive speed of the motor vehicle and generates a detection signal corresponding to the drive speed of the motor vehicle. The obstacle detection sensor 3 detects the presence of an obstacle in front of or in back of the motor vehicle within a predetermined detection range, and a distance from the motor vehicle to the detected obstacle, and outputs a detection signal with lidar, millimeter-wave radar, or sonar radar, etc.

The alarm device 4 is equipped with an image display device and one or more speakers. The image display device displays various warning images to the driver of the motor vehicle. Further, the alarm device 4 provides vocal warnings to the driver through the speakers.

The brake control device 5 controls a brake mechanism (for example, a fluid pressure type, air pressure type, disk brake type, or a drum brake type, etc.), and generates a brake pressure, which corresponds to the amount of depressing the brake pedal of the motor vehicle, in the wheel cylinders of each wheel of the motor vehicle. This makes it possible to generate brake force in the motor vehicle. When receiving a brake instruction transmitted from the conflict control device 9, the brake control device 5 generates the breaking force corresponding to the received brake instruction in each wheel cylinder of the motor vehicle.

The engine control device 6 controls the operation of the internal combustion engine of the motor vehicle. Specifically, the engine control device 6 calculates a ratio of opening of the throttle valve on the basis of the accelerator opening amount (corresponding to the amount of depressing the accelerator pedal). The engine control device 6 controls the engine throttle to open on the basis of the calculated throttle opening amount.

When receiving a throttle opening instruction transmitted from the conflict control device 9, the engine control device 6 detects the driving condition of the motor vehicle, and adjusts the throttle opening amount on the basis of the detected driving condition and the received throttle opening instruction. For example, when the conflict control device 9 transmits an instruction to close the engine throttle completely in order to stop the forward/backward movement of the motor vehicle, the engine control device 6 receives the instruction and adjusts the throttle opening amount in order to operate the internal combustion engine of the motor vehicle, for example, to enter the internal combustion engine into idling mode. This makes it possible to prevent the internal combustion engine of the motor vehicle from being completely stopped.

The collision reduction and escaping control device 7 detects the possibility for the motor vehicle to cause a collision with an obstacle when the motor vehicle drives at a slow drive speed or the motor vehicle is stopped. The collision reduction and escaping control device 7 outputs the detection result as a low speed PCS enable flag to the conflict control device 9.

The accelerator pedal incorrect operation judgment device 8 detects an occurrence of incorrect operation by the driver to the accelerator pedal 13 of the motor vehicle 10 in which the driver strongly depresses, for example, many time, or deeply depresses the accelerator pedal 13. The accelerator pedal incorrect operation judgment device 8 generates and outputs, as a detection result, an accelerator pedal incorrect operation detection flag to the conflict control device 9. The basic function of the accelerator pedal incorrect operation judgment device 8 detects a driver's incorrect operation of the accelerator pedal when the driver intends to depress the brake pedal, namely, when the driver causes unintended operation of the accelerator pedal.

On the other hand, the conflict control device 9 controls the alarm device 4, the brake control device 5 and the engine control device 6 in order to avoid the motor vehicle from colliding with an obstacle or to assist the incorrect operation by the driver to the acceleration pedal on the basis of the received low speed PCS enable flag transmitted from the collision reduction and escaping control device 7 and the accelerator pedal incorrect operation detection flag transmitted from the accelerator pedal incorrect operation judgment device 8.

For example, each of the above devices and functions such as the accelerator pedal incorrect operation judgment device 8, the accelerator pedal incorrect operation judgment device 8, and the conflict control device 9 is realized by the electric control unit (ECU). The ECU as each of the devices 7, 8 and 9 shown in FIG. 1 is generally equipped with a control circuit and a communication interface, etc. The control circuit in the ECU is comprised of a central processing unit (CPU), a random access memory (RAM), a read only memory (ROM), etc. The ECU communicates the various types of the devices through the communication interface and the communication lines such as the in-vehicle LAN.

A description will now be given of actual operation of each of the collision reduction and escaping control device 7, the accelerator pedal incorrect operation judgment device 8 and the conflict control device 9 with reference to diagrams.

The CPU in the ECU as the collision reduction and escaping control device 7 reads a program stored in the ROM, and executes the program periodically every period of 100 ms.

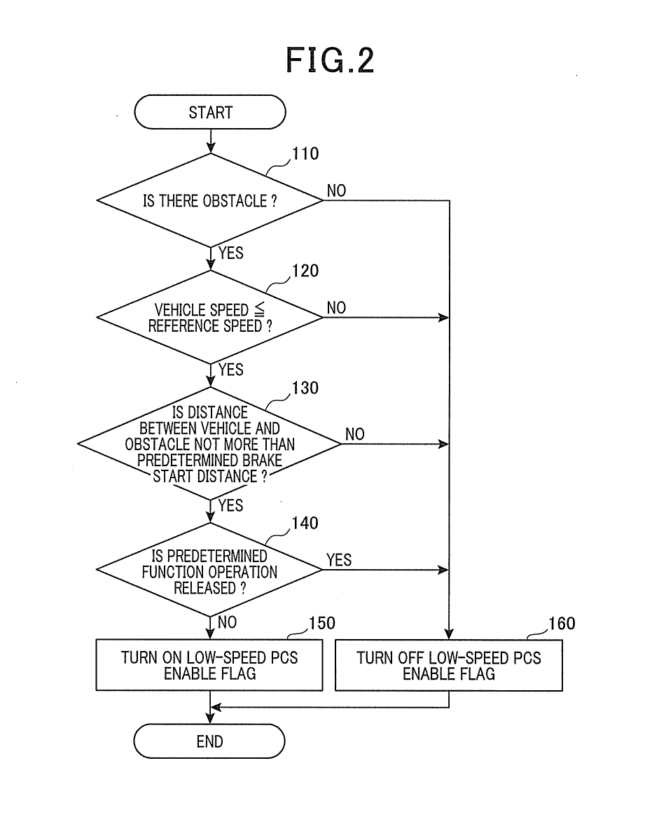

FIG. 2 is a flow chart showing the operation process executed by the collision reduction and escaping control device 7 in the in-vehicle system 100 shown in FIG. 1.

In step S110 shown in FIG. 2, the collision reduction and escaping control device 7 detects whether or not an obstacle is present in front of the motor vehicle, namely, in the forward direction thereof, on the basis of the output signal transmitted from the obstacle detection sensor 3. Specifically, when the obstacle detection sensor 3 outputs a detection signal which indicates the distance between the motor vehicle and the found obstacle which is present in front of the motor vehicle, the collision reduction/avoiding control device 7 receives the detection signal transmitted from the obstacle detection sensor 3 and judges that the obstacle is found and present in front of the motor vehicle in the forward direction.

The collision reduction and escaping control device 7 judges whether the motor vehicle drives in the forward direction or in the backward direction on the basis of a detection signal as a detection result regarding a gear shift position of the gear shift lever position sensor (not shown) of the motor vehicle. In step S110, when the detection result indicates that there is an obstacle (“YES” in step S110), the operation flow goes to step S120. On the other hand, when the detection result indicates that there is no obstacle (“NO” in step S110), the operation flow goes to step S160.

When the detection result in step S110 indicates that an obstacle is found, the collision reduction and escaping control device 7 judges in step S120 whether or not a vehicle speed of the motor vehicle is not more than a reference speed (as a predetermined speed, for example, 30 km/h) on the basis of the output signal of the speed sensor 2. When the judgment result in step S120 indicates that the vehicle speed is not more than the reference speed (“YES” in step S120), the operation flow goes to step S130.

On the other hand, when the judgment result in step S120 indicates that the vehicle speed exceeds the reference speed (“NO” in step S120), the operation flow goes to step S160.

In step S130, the collision reduction and escaping control device 7 judges on the basis of the output signal of the obstacle detection sensor 3 whether or not a distance between the motor vehicle and the obstacle is not more than a predetermined brake start distance. For example, the predetermined brake start distance becomes 11.7 m when a time to collision (TTC) is 1.4 seconds and the current vehicle speed is 30 km/h.

When the judgment result in step S130 indicates that the distance to the obstacle is not more than the predetermined brake start distance (“YES” in step S130), the operation flow goes to step S140. On the other hand, when the judgment result in step S130 indicates that the distance to the obstacle exceeds the predetermined brake start distance (“NO” in step S130), the operation flow goes to step S160.

The operation flow according to the series of steps S110, S120, S130 and S140 indicates that vehicle speed is relatively low and an obstacle is present within the brake start distance. This case has a high possibility for the motor vehicle to collide with the obstacle.

In step S140, the collision reduction and escaping control device 7 judges whether or not the predetermined functional operation is completed. It can be judged whether or not the predetermined functional operation is completed on the basis of checking a value of a function releasing operation flag.

The function releasing operation flag is reset when a main power source IG of the motor vehicle is turned off. The function releasing operation flag is turned on when the predetermined functional operation is completed during the period counted from the time when the previous process shown in FIG. 2 is executed to the time when the current process shown in FIG. 2 is executed.

When the function releasing operation flag is turned on by the function releasing operation once, the function releasing operation flag continuously has its turned-on state until the main power source is turned off or the functional setting process is completed.

It is acceptable as the functional setting process for the driver of the motor vehicle to operate a switch or to the time elapsed of a constant period (for example, 30 minutes).

When the collision reduction and escaping control device 7 judges in step S140 that the function releasing operation is completed (“YES” in step S140), the operation flow goes to step S150. On the other hand, when the collision reduction and escaping control device 7 judges in step S140 that the function releasing operation is not completed (“NO” in step S140), the operation flow goes to step S160.

In step S150, the collision reduction and escaping control device 7 sets a low-speed PCS enable flag to be turned on, and transmits the low-speed PCS enable flag to the conflict control device 9. The conflict control device 9 receives the low-speed PCS enable flag, and stores it as the current low-speed PCS enable flag in the RAM of the control circuit therein.

In step S160, the collision reduction and escaping control device 7 sets the low-speed PCS enable flag to be turned off, and transmits the low-speed PCS enable flag to the conflict control device 9. The conflict control device 9 receives the low-speed PCS enable flag, and stores it in the RAM of the control circuit therein as the current low-speed PCS enable flag.

After the execution of the process shown in the step S150 and step S160, the current process shown in FIG. 2 is completed.

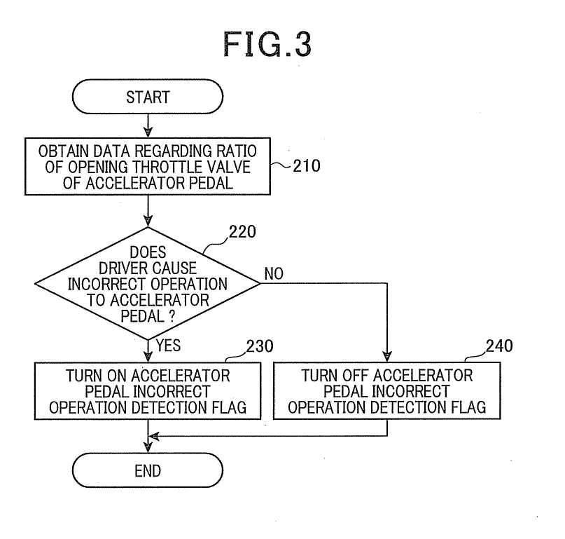

Next, a description will now be given of the operation of the accelerator pedal incorrect operation judgment device 8 with reference to FIG. 3. FIG. 3 is a flow chart showing the process executed by the accelerator pedal incorrect operation judgment device 8. The accelerator pedal incorrect operation judgment device 8 detects an incorrect operation of the accelerator pedal in the in-vehicle system 100 shown in FIG. 1.

The CPU in the control device of the accelerator pedal incorrect operation judgment device 8 executes the program stored in the ROM therein executed the process shown in FIG. 3 repeatedly (for example, every a period of 100 ms.

In step S210 shown in FIG. 3, the accelerator pedal incorrect operation judgment device 8 obtains data regarding a ratio of opening of the throttle of the accelerator pedal on the basis of the output signal transmitted from the accelerator opening sensor 1. This output signal corresponds to an accelerator opening amount, namely, the amount of a depressing stroke of the accelerator pedal.

In step S220, the accelerator pedal incorrect operation judgment device 8 judges whether or not an incorrect operation of the accelerator pedal 13 is occurred. In the incorrect operation, the driver deeply or strongly depresses the accelerator pedal 13 of the motor vehicle 10, for example, many time, on the basis of a current ratio and a previous ratio of opening of the throttle of the accelerator pedal obtained in step S210.

There is a detection method to detect occurrence of the incorrect operation in which the driver strongly or deeply depresses the accelerator pedal 13 of the motor vehicle 10, for example, many time on the basis of the ratio of opening of the throttle of the accelerator pedal. For example, it is detected whether or not the ratio of opening of the throttle of the accelerator pedal per unit time exceeds a predetermined threshold value.

When the judgment result in step S220 indicates the occurrence of incorrect operation of the accelerator pedal 13 (“YES” in step S220), the operation flow goes to step S230. On the other hand, the judgment result in step S220 indicates no occurrence of incorrect operation of the accelerator pedal 13 of the motor vehicle 10 (“NO” in step S220), the operation flow goes to step S240.

In step S230, the accelerator pedal incorrect operation judgment device 8 sets the accelerator pedal incorrect operation detection flag to be turned on, and transmits the accelerator pedal incorrect operation detection flag of the turned-on state to the conflict control device 9.

On the other hand, in step S240, the accelerator pedal incorrect operation judgment device 8 sets the accelerator pedal incorrect operation detection flag to be turned off, and transmits the accelerator pedal incorrect operation detection flag of the turned-off state to the conflict control device 9.

The conflict control device 9 receives the current accelerator pedal incorrect operation detection flag currently transmitted from the collision reduction and escaping control device 7, and stores the received flag to the RAM in the control device therein. After the execution of the process shown in step S230 and step S240, the current process shown in FIG. 3 is completed.

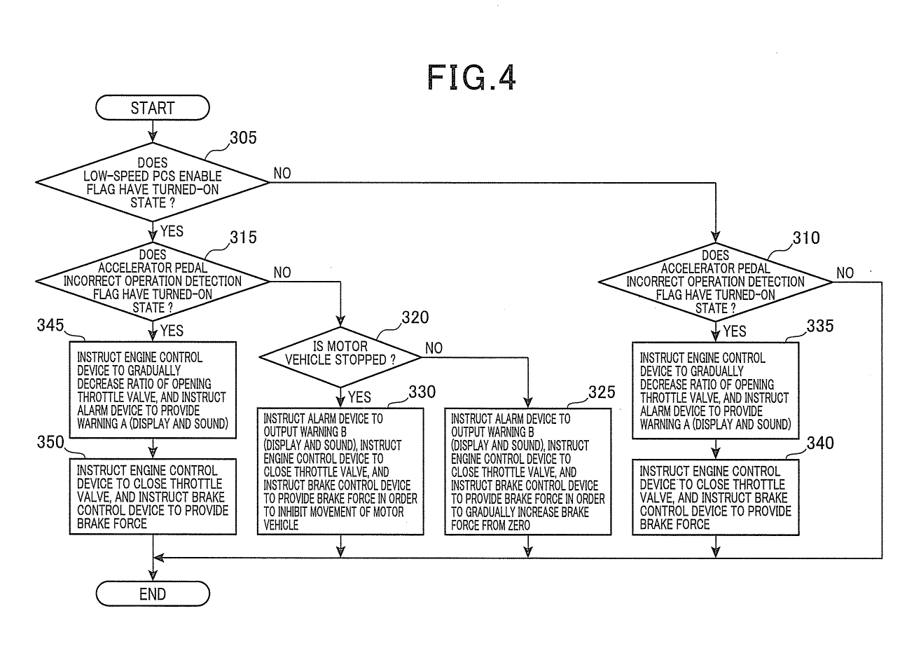

Next, a description will now be given of the operation of the conflict control device 9 with reference to FIG. 4. FIG. 4 is a flow chart showing the process executed by the conflict control device 9 in the in-vehicle system 100 shown in FIG. 1. The CPU in the control device of the ECU as the conflict control device 9 executes the program stored in the ROM in order to repeatedly execute the process shown in FIG. 4.

In the following explanation, the CPU in the control device in each of the collision reduction and escaping control device 7, the accelerator pedal incorrect operation judgment device 8 and the conflict control device 9 is referred to as each of the collision reduction and escaping control device 7, the accelerator pedal incorrect operation judgment device 8 and the conflict control device 9.

In the process shown in FIG. 4, the conflict control device 9 controls the brake control device 5 and the engine control device 6 according to the value of the low-speed PCS enable flag and the accelerator pedal incorrect operation detection flag.

Firstly, the process shown in FIG. 4 will be explained by using plural exemplary cases, the collision reduction and escaping control device 7 and the accelerator pedal incorrect operation judgment device 8.

### [First Exemplary Case]

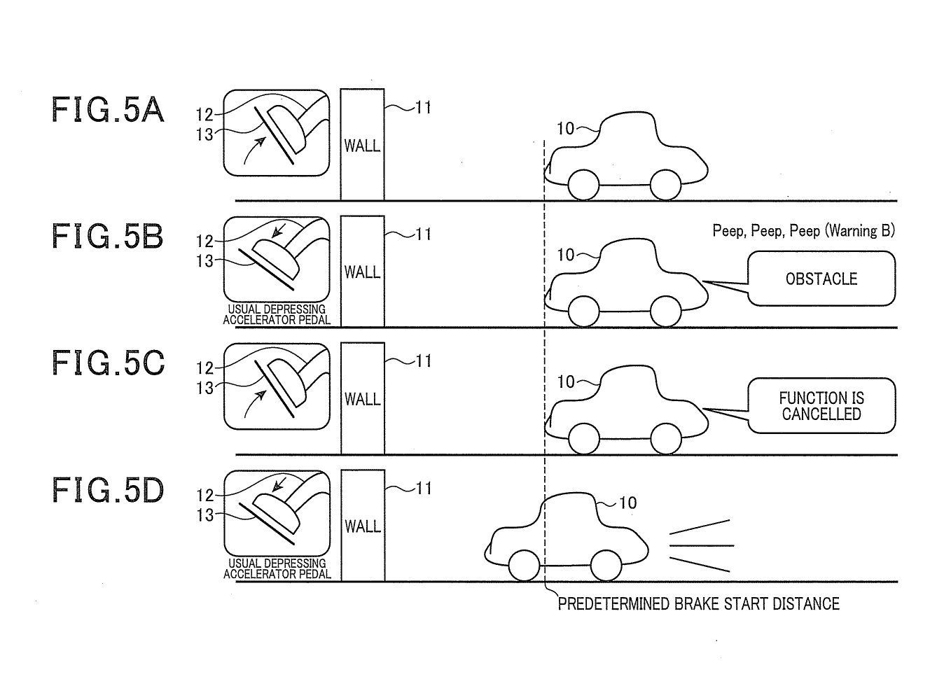

FIG. 5A to FIG. 5D are schematic views showing a first exemplary case under the control of the in-vehicle system 100 shown in FIG. 1.

As shown in FIG. 5A, the motor vehicle 10 equipped with the in-vehicle system 100 is stopped. The distance between the motor vehicle to the obstacle in front of the motor vehicle is within a predetermined brake start distance. The predetermined brake start distance are designated by the dotted line in FIG. 5A to FIG. 5D. At this time, the driver of the motor vehicle does not depress the accelerator pedal 13 and the position of the gear shift lever of the motor vehicle is a forward gear position.

In this state, the collision reduction and escaping control device 7 judges that there is an obstacle in the forward movement direction of the motor vehicle 10 (“YES” in step S110) on the basis of the judgment result in step S110 shown in FIG. 2. The operation flow goes to step S120. The motor vehicle 10 drives. In step S120, the collision reduction and escaping control device 7 judges that the motor vehicle 10 drives at a usual drive speed which is not more than a reference speed (“YES” in step S120). The operation flow goes to step S130. In step S130, the collision reduction and escaping control device 7 judges that the distance between the motor vehicle and the obstacle is not more than the brake start distance (“YES” in step S130). The operation flow goes to step S140. At this time, the collision reduction and escaping control device 7 judges that the driver of the motor vehicle does not use, namely does not execute the function releasing operation (“NO” in step S140) because the function releasing operation flag has not the turned-on state. The operation flow goes to step S150. The collision reduction and escaping control device 7 sets the low-speed PCS enable flag to be turned on, and transmits the low-speed PCS enable flag of the turned-on state to the conflict control device 9.

The operation flow goes to step S210 and step S220. The accelerator pedal incorrect operation judgment device 8 judges that the driver does not cause any incorrect operation of the accelerator pedal 13 of the motor vehicle 10 in step S220 (“NO” in step S220). The operation flow goes to step S240.

In step S240, the accelerator pedal incorrect operation judgment device 8 sets the accelerator pedal incorrect operation detection flag to be turned off, and transmits the accelerator pedal incorrect operation detection flag to the conflict control device 9. That is, the conflict control device 9 receives the low-speed PCS enable flag of the turned-on state and the accelerator pedal incorrect operation detection flag of the turned off state.

In step S305 shown in FIG. 4, the conflict control device 9 judges that the low-speed PCS enable flag has the turned-on state (“YES” in step S305), the operation flow goes to step S315. In step S315, the conflict control device 9 judges that the accelerator pedal incorrect operation detection flag has the turned-off state (“NO” in step S315), the operation flow goes to step S320.

In step S320, the conflict control device 9 judges whether or not the motor vehicle is stopped (“YES” in step S320). Because the motor vehicle is stopped in the first exemplary case, the conflict control device 9 judges that the motor vehicle is stopped (“YES” in step S320). The operation flow goes to step S330. In step S330, the conflict control device 9 instructs the alarm device 4 to output warning B (for example, electric sound of “peep, peep, peep” and display the character “Obstacle”) to the driver of the motor vehicle 10. The conflict control device 9 instructs the engine control device 6 to close the throttle valve completely in order to enter the operation of the internal combustion engine of the motor vehicle into idling state. The conflict control device 9 further instructs the brake control device 5 to generate brake force in order to generate brake pressure at each of the wheel cylinders of the motor vehicle 10. This gradually increases the brake pressure from the minimum value, namely, zero to a predetermined brake pressure.

This control of the engine control device 6 almost closes the throttle valve regardless of the ratio of opening of the throttle valve. The brake control device 5 increases the brake pressure of each wheel of the motor vehicle 10. This control inhibits the forward movement of the motor vehicle 10.

As shown in FIG. 5B, when the foot 12 of the driver depresses the accelerator pedal 13 within a depressed stroke of the usual accelerator operation, the collision reduction and escaping control device 7 executes the same operation shown in FIG. 5A. Accordingly, because the conflict control device 9 receives the low-speed PCS enable flag of the turned-on state and the accelerator pedal incorrect operation judgment device 8 judges in step S220 that there is no incorrect operation (“NO” in step S220), the accelerator pedal incorrect operation detection flag continuously has the turned-off state (in step S240).

Therefore the conflict control device 9 executes the process in step S330, like the case shown in FIG. 5A. Accordingly, even if the driver of the motor vehicle 10 depresses the accelerator pedal 13 within the depressed stroke of the usual accelerator operation, the throttle valve is continuously closed. Further, the motor vehicle is completely stopped because the brake pressure is turned on (which is larger than zero) and the forward movement of the motor vehicle 10 is inhibited.

Still further, it is possible to construct the in-vehicle system 100, as follows. As shown in FIG. 5A and FIG. 5B, the conflict control device 9 does not output any instruction to the alarm device 4 when the driver does not depress the accelerator pedal 13. Therefore the alarm device 4 does not provide warning B to the driver of the motor vehicle 10.

On the other hand, when the driver depresses the accelerator pedal 13, the conflict control device 9 outputs the instruction to the alarm device 4 in order to output warning B (“Peep, Peep, Peep, . . . ”) to the driver.

Next, as shown in FIG. 5C, the driver of the motor vehicle causes the predetermined function releasing operation. In the case shown in FIG. 5C, when the foot 12 of the driver depresses the accelerator pedal 13 and then releases his foot 12 from the accelerator pedal 13, the accelerator pedal 13 is returned to its home position.

In this case shown in FIG. 5C, the collision reduction and escaping control device 7 executes the step S110, the step S120, the step S130 and the step S140 in order. In step S140, the collision reduction and escaping control device 7 judges that the function releasing operation is completed on the basis of the output signal transmitted from the accelerator opening sensor 1, which indicates that the ratio of opening of the accelerator is returned to zero. The operation flow then goes to step S160. In step S160, the collision reduction and escaping control device 7 sets the low-speed PCS enable flag to be turned off, and transmits the low-speed PCS enable flag of the turned-off state to the conflict control device 9.

The conflict control device 9 receives the low-speed PCS enable flag of the turned-off state. Because the driver does not cause any incorrect operation of the accelerator pedal 13, in which the driver does not deeply or strongly depress the accelerator pedal 13 of the motor vehicle 10 many time, the accelerator pedal incorrect operation detection flag continuously has the turned-off state.

In step S305 shown in FIG. 4, the conflict control device 9 detects the turned-off state of the low-speed PCS enable flag. The operation flow goes to step S310. In step S310, because the conflict control device 9 detects the turned-off state of the accelerator pedal incorrect operation detection flag, the first execution of the process shown in FIG. 4 is completed. The process shown in FIG. 4 is repeatedly executed.

Because the conflict control device 9 does not transmit any instruction to the brake control device 5 and the engine control device 6. The brake pressure generated in each wheel cylinder has the continuous pressure corresponding to the stroke of the brake pedal depressed by the driver of the motor vehicle 10. That is, when the driver of the motor vehicle 10 does not depress the brake pedal 13, the brake pressure has the minimum value (zero). The ratio of opening of the throttle valve corresponds to the ratio of opening of the accelerator pedal 13 by the driver of the motor vehicle 10. When the driver does not depress the accelerator pedal 13, the ratio of opening of the throttle value has the same ratio obtained when the internal combustion engine is in the idling operation. Accordingly, at the state shown in FIG. 5C, the motor vehicle 10 is started to move in the forward direction by creep force generated on a contact surface between the wheels and the road.

As shown in FIG. 5D, the driver of the motor vehicle 10 depresses the accelerator pedal 13 within the depressed stroke of the usual acceleration operation. In this case, the collision reduction and escaping control device 7 executes a series of step S110, step S120, step S130 and step S140 in order. Because the function releasing operation flag has the turned-on state in step S140, the collision reduction and escaping control device 7 judges that the function releasing operation is completed (“YES” in step S140). Accordingly, the operation flow goes to step S160. The collision reduction and escaping control device 7 sets the low-speed PCS enable flag to be turned off, and transmits the low-speed PCS enable flag of the turned-off state to the conflict control device 9. The conflict control device 9 has the low-speed PCS enable flag of the turned-off state. Because the driver does not cause any incorrect operation of the accelerator pedal 13, namely, the driver does not deeply or strongly depress the accelerator pedal 13 of the motor vehicle 10, for example, many time, the accelerator pedal incorrect operation detection flag has the turned-off state.

In step S305 shown in FIG. 4, the conflict control device 9 judges that the low-speed PCS enable flag has the turned-off state (“NO” in step S305). The operation flow goes to step S310. In step S310, because the conflict control device 9 judges that the accelerator pedal incorrect operation detection flag has the turned-off state (“NO” in step S310), one cycle of the process shown in FIG. 4 is thereby completed. The process shown in FIG. 4 is repeatedly executed. The motor vehicle 10 moves in the forward direction with a forward speed corresponding to the ratio of opening of the accelerator pedal 13.

### [Second Exemplary Case]

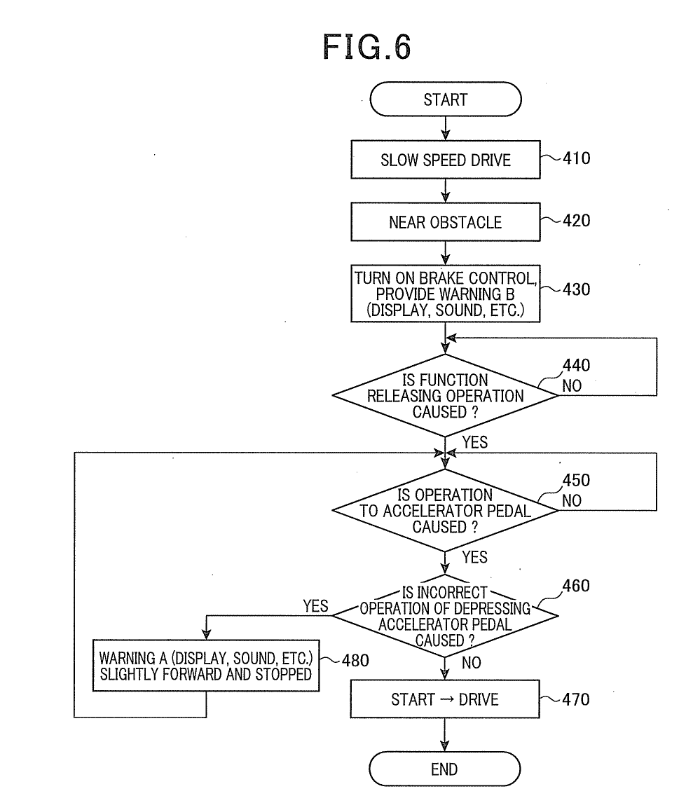

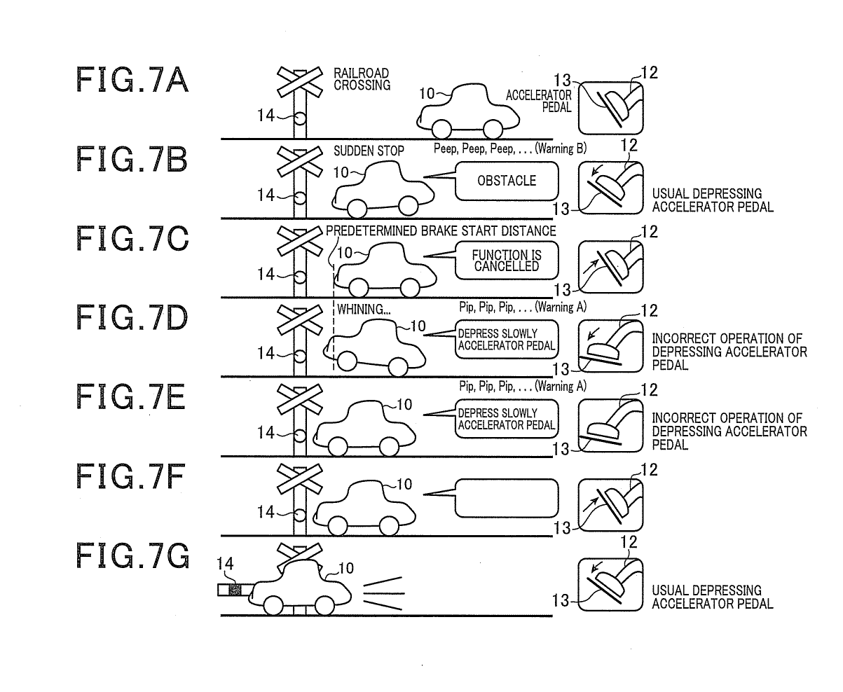

A description will now be given of the second exemplary case with reference to FIG. 6 and FIG. 7.

The second exemplary case shows an accident in which the motor vehicle 10 is trapped inside a railroad crossing.

FIG. 6 is a flow chart showing a procedure of the second exemplary case under the control of the in-vehicle system 100 shown in FIG. 1. FIG. 7A to FIG. 7G are schematic views showing the second exemplary case under the control of the in-vehicle system 100 shown in FIG. 1.

As shown in FIG. 7A, when the motor vehicle 10 equipped with the in-vehicle system 100 enters the railroad crossing at a speed of not more than 30 km/h, and the railroad crossing gate 14 is closed before the motor vehicle 10 goes out of the railroad crossing. That is, the second exemplary case shows that the motor vehicle 10 is trapped inside the railroad crossing. In this case, the distance between the motor vehicle 10 and the railroad crossing gate 14 exceeds the predetermined brake start distance as designated by the dotted line (see FIG. 7C, for example).

In this case, the collision reduction and escaping control device 7 executes a series of step S110, step S120 and step S130 in order. In step S130, because the collision reduction and escaping control device 7 judges that the distance of the motor vehicle 10 exceeds the predetermined brake start distance, the collision reduction and escaping control device 7 sets the low-speed PCS enable flag to be turned off. The collision reduction and escaping control device 7 outputs the low-speed PCS enable flag of the turned-off state to the conflict control device 9.

The accelerator pedal incorrect operation judgment device 8 executes a series of step S210 and step S220. In step S220, the accelerator pedal incorrect operation judgment device 8 judges that there is no incorrect operation (“NO” in step S220). That is, the driver does not cause any incorrect operation of the accelerator pedal 13 because the driver does not deeply or strongly depress the accelerator pedal 13 many time. The accelerator pedal incorrect operation judgment device 8 keeps the accelerator pedal incorrect operation detection flag in the turned-off state (see step S240). Accordingly, the conflict control device 9 has the low-speed PCS enable flag of the turned-off state and the accelerator pedal incorrect operation detection flag of the turned-off state.

In step S305 shown in FIG. 4, the conflict control device 9 judges that the low-speed PCS enable flag has the turned-off state (“NO” in step S305). The operation flow goes to step S310. In step S310, the conflict control device 9 judges that the accelerator pedal incorrect operation detection flag has the turned-off state (“NO” in step S310). The one cycle of the process shown in FIG. 4 is thereby completed. The motor vehicle 10 can move in the forward direction with a forward drive speed which corresponds to the ratio of opening of the accelerator pedal 13. (see step S410 shown in FIG. 6)

When the motor vehicle 10 moves in the forward direction at a forward drive speed of not more than 30 km/h, and approaches the railroad crossing gate 14 within the predetermined brake start distance (see step S420 shown in FIG. 6), the collision reduction and escaping control device 7 executes a series of step S110, step S120 and step S130 shown in FIG. 2 in order. In step S130, the collision reduction and escaping control device 7 judges that the motor vehicle 10 approaches the railroad crossing gate 14 within the predetermined brake start distance. The operation flow goes to step S140. The driver of the motor vehicle 10 does not execute the function releasing operation at this time. Accordingly, because the function releasing operation flag has the turned-off state, the collision reduction and escaping control device 7 judges that the driver of the motor vehicle 10 does not execute the function releasing operation (“NO” in step S140). Accordingly, the operation flow goes to step S150. In step S150, the collision reduction and escaping control device 7 sets the low-speed PCS enable flag to be turned on and transmits the low-speed PCS enable flag of the turned-on state to the conflict control device 9. Because the conflict control device 9 receives the low-speed PCS enable flag of the turned-on state, the conflict control device 9 has the low-speed PCS enable flag of the turned-on state, and the accelerator pedal incorrect operation detection flag of the turned-off state.

In step S305 shown in FIG. 4, the conflict control device 9 judges that the low-speed PCS enable flag has the turned-on state (“YES” in step S305). The operation flow goes to step S 315. In step S315, the conflict control device 9 judges that the accelerator pedal incorrect operation detection flag has the turned-off state (“NO” in step S315). The operation flow goes to step S320.

In step S320, the conflict control device 9 judges whether or not the motor vehicle 10 is stopped. In the second exemplary case, because the motor vehicle 10 now moves, the conflict control device 9 judges that the motor vehicle 10 is not stopped (“NO” in step S320). The operation flow goes to step S325.

In step S325, the conflict control device 9 instructs the alarm device 4 to provide warning B (as the same warning in step S330) to the driver of the motor vehicle 10. The conflict control device 9 instructs the engine control device 6 to close the throttle valve in order to enter the internal combustion engine of the motor vehicle 10 to the idling state. The engine control device 6 further instructs the brake control device 5 to increase the brake pressure, to be generated in the wheel cylinder of each wheel of the motor vehicle 10, from the minimum value (zero). (see step S430 shown in FIG. 6).

The above process controls the engine control device 6 to close the throttle valve regardless of the ratio of opening of the accelerator pedal 13. This suppresses the operation of the internal combustion engine. Further, the brake control device 5 increases the wheel cylinder pressure of each wheel, the brake force is generated in each wheel. Accordingly, the forward movement speed of the motor vehicle 10 is decreased, and the motor vehicle 10 is suddenly stopped before the railroad crossing gate 14.

After the motor vehicle 10 is stopped before the railroad crossing gate 14, the conflict control device 9 executes a series of step S305, step S315 and step S320. In step S320, the conflict control device 9 judges that the motor vehicle 10 is stopped completely (“YES” in step S320). The operation flow goes to step S330. The conflict control device 9 instructs the alarm device 4 to provide warning B (as the same warning in step S330) to the driver of the motor vehicle 10. The conflict control device 9 further instructs the engine control device 6 to close the throttle valve in order to continue the internal combustion engine in the idling state. The engine control device 6 controls the throttle valve to be almost closed regardless of the ratio of opening of the accelerator pedal 13, and suppresses the operation of the internal combustion engine. Further, the brake control device 5 increases the brake pressure of each wheel. This control inhibits the forward movement of the motor vehicle 10.

Next, as shown in FIG. 7C, when the driver of the motor vehicle 10 executes the predetermined function releasing operation (see step S440 shown in FIG. 6), the collision reduction and escaping control device 7 judges that the function releasing operation is completed (“YES” in step S140), as previously explained in the example shown in FIG. 5C. The operation flow goes to step S160. In step S160, the collision reduction and escaping control device 7 sets the low-speed PCS enable flag to be turned off, and transmits the low-speed PCS enable flag of the turned-off state to the conflict control device 9. Accordingly, the conflict control device 9 has the low-speed PCS enable flag of the turned-off state. Because there is no driver's incorrect operation of the accelerator pedal 13, that is, the driver does not deeply or strongly depress the accelerator pedal 13 of the motor vehicle 10, for example, many time at this stage, the accelerator pedal incorrect operation detection flag continuously has the turned-off state.

The conflict control device 9 judges that the low-speed PCS enable flag has the turned-off state (“NO” in step S305 in FIG. 4). The operation flow goes to step S310. In step S310, the conflict control device 9 judges that the accelerator pedal incorrect operation detection flag has the turned-off state (“NO” in step S310). One cycle of the process shown in FIG. 4 is completed. The process shown in FIG. 4 is repeatedly executed. In this case, the brake pressure of each wheel corresponds to a depressed stroke amount of the brake pedal depressed by the driver of the motor vehicle 10. The ratio of opening of the throttle valve corresponds to the ratio of opening of the accelerator pedal 13.

After this, as shown in FIG. 7D, the driver of the motor vehicle suddenly depresses the accelerator pedal 13 many time in order to go out from the inside of the railroad crossing. (see step S450 and step S460 shown in FIG. 6)

Because the function releasing operation flag has the turned-off state, the collision reduction and escaping control device 7 executes a series of step S110, step S120, step S130 and step S140 in order. Because the collision reduction and escaping control device 7 sets the low-speed PCS enable flag to be turned off, the conflict control device 9 has the low-speed PCS enable flag of the turned-off state.

However, the accelerator pedal incorrect operation judgment device 8 judges that there is incorrect operation in which the driver deeply or strongly depresses the accelerator pedal 13 of the motor vehicle 10 many time in step S220 following step S210. In step S230, the accelerator pedal incorrect operation judgment device 8 sets the accelerator pedal incorrect operation detection flag to be turned on and transmits the accelerator pedal incorrect operation detection flag of the turned-on state to the conflict control device 9. The conflict control device 9 has the accelerator pedal incorrect operation detection flag of the turned-on state.

Because the conflict control device 9 judges that the low-speed PCS enable flag has the turned-off state (“NO” in step S305), the operation flow goes to step S310. In step S310, because the conflict control device 9 judges that the accelerator pedal incorrect operation detection flag has the turned-on state (“YES” in step S310), the conflict control device 9 executes the process of step S335 and step S340 shown in FIG. 4 in order.

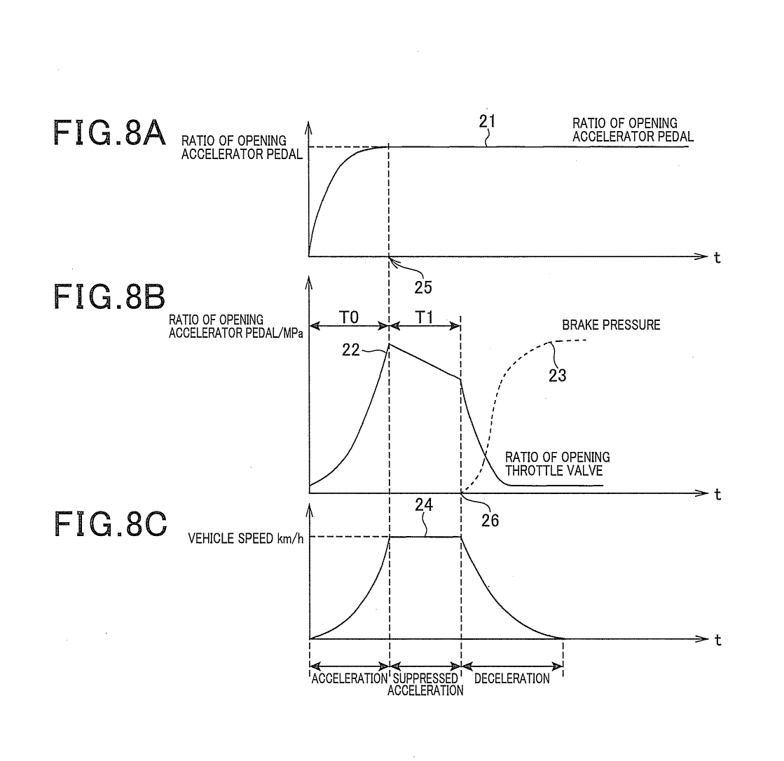

FIG. 8A to FIG. 8C are views, each showing a change of the brake pressure and the throttle opening when the driver of the motor vehicle 10 causes an unintended depressing of the accelerator pedal 13. That is, FIG. 8A, FIG. 8B and FIG. 8C show the time elapsed of the ratio 21 of opening of the accelerator pedal 13, the ratio 22 of opening of the throttle valve of the internal combustion engine, the brake pressure 23 and the vehicle speed 24 according to the control of the step S335 and step S340.

Specifically, in step S335, the conflict control device 9 does not instruct the brake control device 5 to generate brake force within a predetermined period of time counted from the time when the current process shown in FIG. 4 is initiated (which is almost equal to the time 26 when the accelerator pedal incorrect operation detection flag is turned on). The conflict control device 9 instructs the engine control device 6 to gradually decrease the ratio of opening of the throttle valve, and instructs the alarm device 4 to provide warning A “Pip, Pip, Pip, . . . ” to the driver of the motor vehicle 10, which is different from warning B “Peep, Pep, Peep, . . . ”. The warning A is a high pitched computer sound “Peep, Peep, Peep, . . . ” as onomatopoeia made by a computer or a machine. In addition, the warning A display a message to the driver “Please depress the accelerator pedal slowly” through a monitor device (not shown).

Because the conflict control device 9 does not instruct the brake control device 5, the brake pressure to be generated in the wheel cylinder of each wheel has the minimum value (zero) unless the driver depresses the brake pedal. In this case, when the driver depresses the brake pedal 13, the brake pressure is increased from the minimum value and the brake force to the wheels is generated. Although this case gradually generates such a brake force, the conflict control device 9 allows the motor vehicle 10 to move the forward direction.

When the conflict control device 9 instructs the engine control device 6 to gradually decrease the ratio of opening of the throttle valve, the engine control device 6 decreases the ratio 22 of opening of the throttle valve according to the time elapsed regardless of the ratio of opening of the accelerator pedal even if the ratio 21 of opening of the accelerator pedal has the maximum value during the period T1 of time.

This control suppresses the vehicle speed 24 from being increased during the period T1 of time, and this control prevents the motor vehicle from performing quick acceleration. However, unless the driver of the motor vehicle 10 depresses the accelerator pedal 13, the motor vehicle 10 is not stopped by brake force because the brake pressure has the minimum value, and the motor vehicle moves slowly in the forward direction shown in FIG. 7D.

It is acceptable to use a fixed period T1 of time (for example, one second), or a variable period of time (for example, a period of time which is changed according to the presence of an obstacle which is present in front of the motor vehicle 10), or a period of time necessary to move to a predetermined distance (for example, 2 km). When the period of time Ts has been elapsed at time 26, the conflict control device 9 executes step S340 after completion of executing step S335.

In step S340, the conflict control device 9 instructs the engine control device 6 to close the throttle valve. The engine control device 6 suddenly decreases the ratio (as designated by the curve 22 in FIG. 8B) of opening of the throttle valve according to the instruction transmitted from the conflict control device 9. This control makes the throttle valve to be almost closed in order to suppress the operation of the internal combustion engine of the motor vehicle.

In step S340, the conflict control device 9 starts to output the instruction to the brake control device 5. This control makes the brake control device 5 to increase the brake pressure (as designated by the curve 23 in FIG. 8B) of each wheel cylinder from the minimum value regardless of the amount of the depressed stroke to the brake pedal. As shown in FIG. 7E, this control stops the motor vehicle 10. The current process shown in FIG. 4 is completed after completion of executing step S340.

As described above, the conflict control device 9 allows the motor vehicle 10 to slightly move to the forward movement direction and to be stopped in step S335 and step S340 (see step S480 shown in FIG. 6) when the driver of the motor vehicle 10 causes incorrect operation of the accelerator pedal 13, that is, when the driver deeply or strongly depresses the accelerator pedal 13 of the motor vehicle 10, for example, many time. (see step S460 shown in FIG. 6).

As previously explained in detail, the in-vehicle system 100 allows the motor vehicle 10 to move in the forward direction within the predetermined period T1 of time counted from the time 25 (see FIG. 8A, FIG. 8B and FIG. 8C) when the driver just causes incorrect operation, that is, from the time 25 when the driver deeply or strongly depress the accelerator pedal 13 of the motor vehicle 10, and the motor vehicle 10 is then stopped after the elapse of the predetermined period T1 of time. This control makes it possible for the motor vehicle 10 to slightly move in the forward direction and then to be stopped even if the motor vehicle 10 is trapped inside an dangerous area such as a railroad crossing and the driver of the motor vehicle 10 is confused and deeply depresses the accelerator pedal 13 many time.

Accordingly, even if the driver repeatedly tries such incorrect operation of the accelerator pedal 13 in order to escape from the dangerous area such as from the inside of the railroad crossing (step S450, step S460 and step S480 shown in FIG. 6), it is possible to move the motor vehicle 10 and to escape from the inside of the railroad crossing.

As previously described, the obstacle escaping function is executed on the basis of the detection result of the collision reduction and escaping control device 7 when the motor vehicle 10 is present before the obstacle 14, and the vehicle control function (as the incorrect operation measure assistance function) is executed on the basis of the detection result of the accelerator pedal incorrect operation judgment device 8 when the driver suddenly and deeply depresses the accelerator pedal 13, for example, many time.

In the motor vehicle 10 equipped with the in-vehicle system 100 having both the functions, the obstacle escaping function and the vehicle control function (as the incorrect operation measure assistance function), the forward movement of the motor vehicle 10 which is stopped before the obstacle 14 is inhibited when the obstacle escaping function works (see FIG. 5B).

On the other hand, the in-vehicle system 100 allows the motor vehicle 10 to move in the forward direction during the predetermined period T1 of time and to be stopped after the elapse of the predetermined period T1 of time after the driver of the motor vehicle 10 causes incorrect operation of the accelerator pedal 13 when the vehicle control function (as the incorrect operation measure assistance function) works (see FIG. 7D and FIG. 7E). Thus, the obstacle escaping function is different from the vehicle control function (as the incorrect operation measure assistance function). Accordingly, the driver can easily recognize the difference between these functions and which function is now executed or works.

### Comparative Example

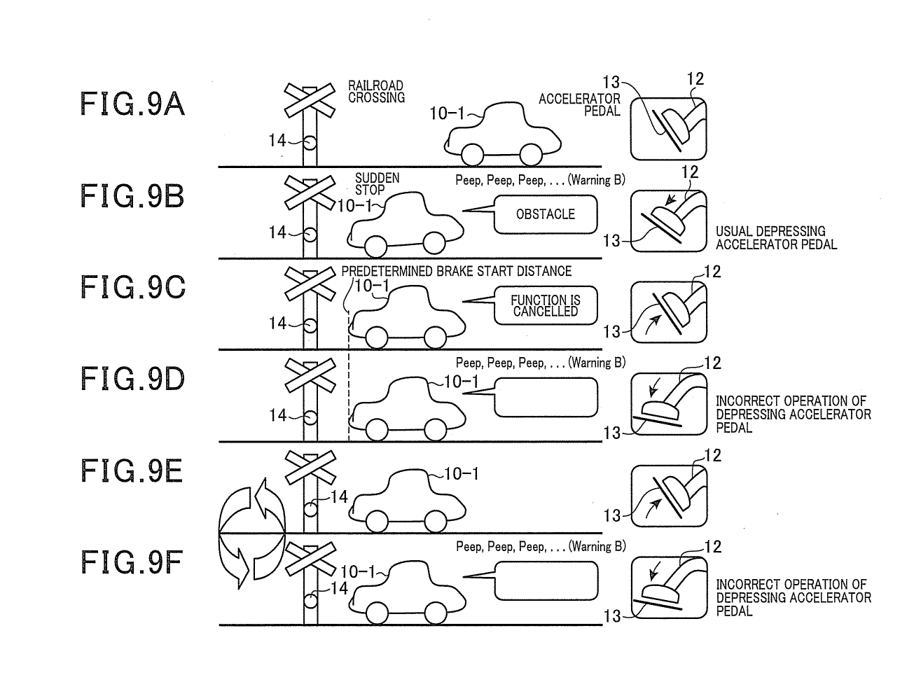

FIG. 9A to FIG. 9F are views showing a comparative example in which the motor vehicle 10-1 is equipped with a conventional in-vehicle system in which both functions, the obstacle escaping function and the vehicle control function (as the incorrect operation measure assistance function) have the same operation or action. This comparative case would have a possibility of generating the case shown in FIG. 9A to FIG. 9F, and the driver of the motor vehicle 10-1 cannot recognize a difference between these functions, in other words, the driver cannot distinguish these functions because the conventional in-vehicle system does not have the features and functions of the in-vehicle system 100 according to the exemplary embodiments as previously described.

For example, the following situation will now be considered. When the motor vehicle 10-1 drives at a slow speed and enters inside a railroad crossing, the railroad crossing gate 14 at the exit side is closed before the motor vehicle 10-1 goes out from the railroad crossing. (see FIG. 9A)

When the motor vehicle 10-1 is now present within the brake start distance counted (designated by the dotted line in FIG. 9C and FIG. 9D) from the railroad crossing gate 14 (see FIG. 9B), the low speed PCS enable flag is turned on. Because the obstacle escaping function generates brake force to the motor vehicle 10-1, the motor vehicle 10-1 is suddenly stopped.

During the stop of the motor vehicle 10-1, the driver releases the obstacle escaping function, the low speed PCS enable flag is turned off, and the obstacle escaping function does not work. (see FIG. 9C).

After this, when the driver of the motor vehicle 10-1 is confused in order to escape from the railroad crossing, the driver deeply or strongly depresses the accelerator pedal 13 of the motor vehicle many time. (see FIG. 9D) In this case, the accelerator pedal incorrect operation detection flag is turned on, so that the vehicle control function (as the incorrect operation measure assistance function) works, and the forward movement of the motor vehicle 10-1 is limited like the case of the obstacle escaping function. The driver of the motor vehicle 10-1 is confused because the obstacle escaping function is now working although the driver executes the function releasing operation of the obstacle escaping function. In this case, because the driver is confused, there is a possibility that the driver further depresses the accelerator pedal 13 repeatedly. (see FIG. 9E and FIG. 9F)

On the other hand, the in-vehicle system 100 according to the first exemplary embodiment, as previously described in detail, has both the functions, the obstacle escaping function and the vehicle control function (as the incorrect operation measure assistance function) which are different to each other in behavior and motion. That is, because the in-vehicle system 100 shows the obstacle escaping function and the vehicle control function (as the incorrect operation measure assistance function) in different motions, the driver of the motor vehicle 10 can easily distinguish these functions, and can easily distinguish which function is now working. It is possible for the driver to know that the driver himself recognizes that the driver depresses the accelerator pedal 13 too much when the vehicle control function (as the incorrect operation measure assistance function) works. Accordingly, as shown in FIG. 7F, the driver can release his foot from the accelerator pedal 13 once, and then the driver can depress the accelerator pedal 13 within the predetermined stroke.

The collision reduction and escaping control device 7 judges that the driver executes the function releasing operation because the function releasing flag is still turned on in step S140. The operation flow goes to step S160. In step S160, the collision reduction and escaping control device 7 sets the low-speed PCS enable flag to be turned off, and transmits the low-speed PCS enable flag of the turned-off state to the conflict control device 9.

The accelerator pedal incorrect operation judgment device 8 judges that the driver does not cause the incorrect operation of the accelerator pedal 13 in step S220. The operation flow goes to step S240. In step S240, the accelerator pedal incorrect operation judgment device 8 sets the accelerator pedal incorrect operation detection flag to be turned off, and transmits the accelerator pedal incorrect operation detection flag of the turned-off state to the conflict control device 9. The conflict control device 9 repeatedly executes the process of step S305 and the process of step S310, and does not output any instruction to the brake control device 5 and the engine control device 6. Accordingly, the motor vehicle 10 moves in the forward direction by a driving force corresponding to the ratio of opening of the accelerator pedal 13. As shown in FIG. 7G, the motor vehicle 10 can break the railroad crossing gate 14 in order to escape from the railroad crossing. (see step S470 shown in FIG. 6)

By the way, there is a possibility of turning on both the low-speed PCS enable flag and the accelerator pedal incorrect operation detection flag simultaneously in the conflict control device 9. For example, as shown in FIG. 7B, in the case in which the low-speed PCS enable flag is turned on, the accelerator pedal incorrect operation detection flag is turned off, the driver of the motor vehicle does not execute the predetermined function releasing operation and does not deeply or strongly depress the accelerator pedal 13 with a large depressed stroke, the operation flow goes to step S230 from step S220, and the accelerator pedal incorrect operation judgment device 8 sets the low-speed PCS enable flag to be turned on, and transmits the low-speed PCS enable flag of the turned-on state to the conflict control device 9. Accordingly, the conflict control device 9 receives and has the low-speed PCS enable flag of the turned-on state.

As described above, when both the low-speed PCS enable flag and the accelerator pedal incorrect operation detection flag are turned on simultaneously, the conflict control device 9 judges that the low-speed PCS enable flag has the turned-on state in step S305 shown in FIG. 4 (“YES” in step S305). The operation flow goes to step S315. In step S315, the conflict control device 9 judges that the accelerator pedal incorrect operation detection flag has the turned-on state (“YES” in step S315). The operation flow goes to step S345. The process in step S345 and step S350 has the same process in step S335 and step S340. That is, the in-vehicle system 100 executes only the accelerator pedal incorrect operation preventing assistance function which corresponds to the turned-on state of the accelerator pedal incorrect operation detection flag, does not corresponds to the low-speed PCS enable flag.

As previously described in detail, the conflict control device 9 can execute the accelerator pedal incorrect operation measure assistance function rather than the execution of the obstacle escaping function in the following conditions:

(1) There is an obstacle which is present within the predetermined brake start distance in the forward direction of the motor vehicle;

(2) The movement speed of the motor vehicle 10 is not more than the reference moving speed;

(3) The low-speed PCS enable flag has the turned-on state; and

(4) The accelerator pedal incorrect operation detection flag has the turned-on state when the driver of the motor vehicle causes incorrect operation of the accelerator pedal 13 of the motor vehicle 10, that is, the driver deeply or strongly depresses the acceleration pedal 13 many time.

This makes it possible to quickly inform to the driver the occurrence of incorrect operation of the accelerator pedal 13, that is, the driver deeply or strongly depress the accelerator pedal 13 of the motor vehicle 10 many time, and to introduce the driver of the motor vehicle to be able to try the usual depressing operation of the accelerator pedal 13, namely, be able to depress the accelerator pedal 13 within an usual depressing stroke as soon as possible.

### Second Exemplary Embodiment

A description will be given of the in-vehicle system according to the second exemplary embodiment of the present invention.

### (First Case)

In the first exemplary embodiment previously described, the conflict control device 9 executes the process in step S335 and step S340 (or in step S345 and step S350) when the driver causes incorrect operation in which the driver deeply or strongly depresses the accelerator pedal 13 of the motor vehicle 10 many time, and the accelerator pedal incorrect operation detection flag is thereby turned on.

However, it is possible for the in-vehicle system 100 to execute the following process. That is, when the driver causes first incorrect operation, that is, when the driver deeply or strongly depresses the accelerator pedal 13 of the motor vehicle 10, and the accelerator pedal incorrect operation detection flag is turned on from its turned-off state, the conflict control device 9 executes the process shown in step S320 and the following steps, does not execute the process shown in step S335 (or the process shown in step S345), and then immediately inhibits the forward movement of the motor vehicle 10. Secondary, when the driver causes a second incorrect operation in which the driver deeply or strongly depresses the accelerator pedal 13 of the motor vehicle 10 again, and the accelerator pedal incorrect operation detection flag is thereby turned on, it is possible for the conflict control device 9 to execute the process in step S335 and step S340 (or the process in step S345 and step S350). In this case, the process in step S325 and step S330 after step S320 provides warning A “Pip, Pip, Pip, . . . ”) to the driver of the motor vehicle 10 instead of warning B.

That is, when there is an obstacle in front of the forward direction of the motor vehicle 10 and the driver of the motor vehicle 10 causes the incorrect operation of the accelerator pedal 13 for the first time in which the driver deeply or strongly depresses the accelerator pedal 13 of the motor vehicle 10 for the first time, the in-vehicle system 100 inhibits the forward movement of the motor vehicle 10. When the driver of the motor vehicle 10 causes a second-time or more-time occurrence of the incorrect operation of the accelerator pedal 13 after the first-time occurrence of the incorrect operation of the accelerator pedal 13, the in-vehicle system 100 slightly moves the motor vehicle 10 in the forward direction and then inhibits the forward movement of the motor vehicle.

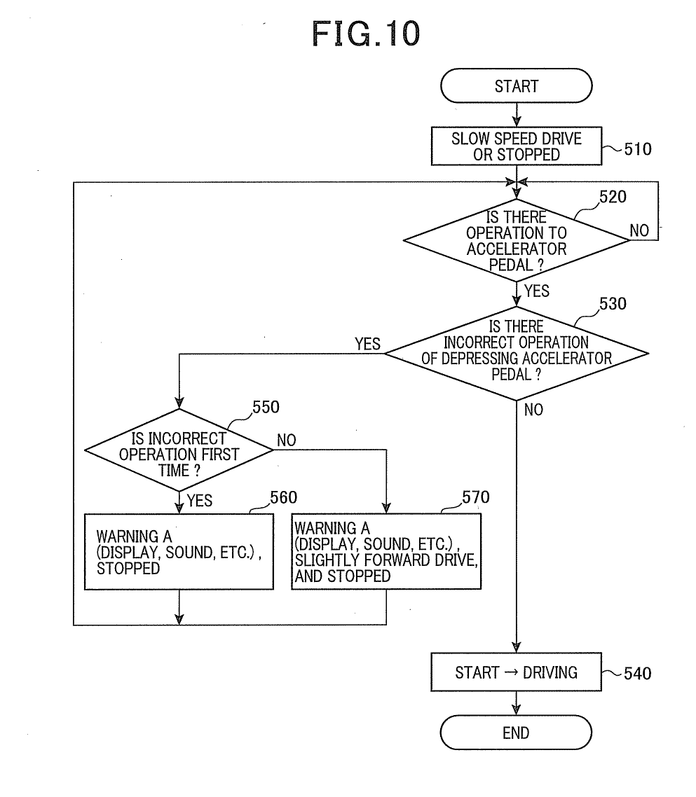

FIG. 10 is a flow chart showing a procedure of the in-vehicle system according to the second exemplary embodiment of the present invention;

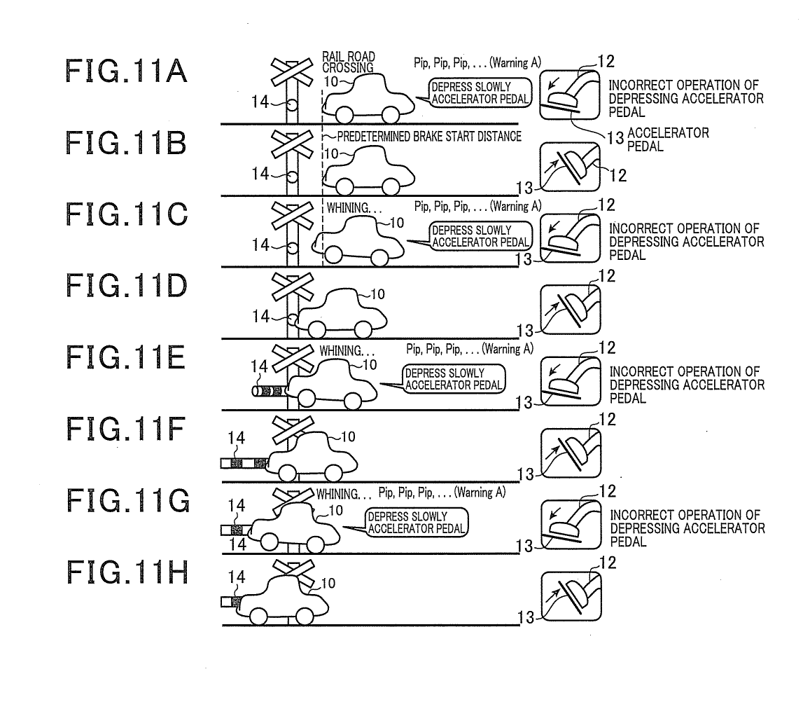

FIG. 11A to FIG. 11H are views showing another exemplary case executed by the in-vehicle system according to the second exemplary embodiment of the present invention.

As shown in FIG. 10 and FIG. 11, when the driver causes a first-time occurrence of the incorrect operation of the accelerator pedal 13 of the motor vehicle 10 (see step S520 and step S530) while the motor vehicle 10 drives at a low speed or is stopped (see step S510 shown in FIG. 10), the in-vehicle system 100 provides warning A (“Pip, Pip, Pip, . . . ” and “Depress the accelerator pedal slowly”) to the driver, and inhibits the forward movement of the motor vehicle 10 after providing warning A (see step S560 shown in FIG. 11A).

After this, when the driver releases his foot from the accelerator pedal 13 and the accelerator pedal 13 is returned its original position (see FIG. 11B), and when the driver causes second-time incorrect operation of the accelerator pedal 13 of the motor vehicle 10 (step S520 and step S530), the in-vehicle system 100 provides warning A (“Pip, Pip, Pip, . . . ” and “Depress the accelerator pedal slowly”) to the driver, and allows the motor vehicle to slightly move in the forward direction, and then inhibits the forward movement of the motor vehicle. The motor vehicle 10 is thereby stopped (see step S570 and FIG. 11C to FIG. 11H).

The in-vehicle system 100 executes the above control because the driver is confused and causes incorrect operation of the accelerator pedal 13 of the motor vehicle 10 (that is, because the driver depresses the accelerator pedal 13 many time) in order to move the motor vehicle in the forward direction. The above control to slightly move the motor vehicle 10 and then to stop the motor vehicle 10 increases the safety of the motor vehicle 10 and the driver when the in-vehicle system 100 detects the first incorrect operation of the accelerator pedal 13 of the motor vehicle 10.

The conflict control device 9 has a counter memory device in order to store the number of occurrence of incorrect operation of the accelerator pedal 13 of the motor vehicle 10. The data stored in the counter memory is reset every time when the in-vehicle system 100 starts, and updated by one every time when the driver causes incorrect operation of the accelerator pedal 13 of the motor vehicle 10. However, the data stored in the counter memory is reset with zero every time when the driver executes the usual operation of the accelerator pedal 13. Still further, the data stored in the counter memory is reset with zero when a predetermined period of time (for example, 30 seconds) is elapsed counted from the occurrence of the last incorrect operation of the accelerator pedal 13 of the motor vehicle 10.

Because the driver causes incorrect operation of the accelerator pedal 13 of the motor vehicle 10 and the counter memory is updated by one, the conflict control device 9 judges that the driver causes the first incorrect operation of the accelerator pedal 13 of the motor vehicle 10 when the data stored in the counter memory indicates the value of “1”, and judges that the driver causes incorrect operation of the accelerator pedal 13 plural times of not less than two when the data stored in the counter memory indicates the value of not less than “2”.

That is, the first-time occurrence of incorrect operation, in which the driver deeply or strongly depresses the accelerator pedal 13 of the motor vehicle 10 at the first time, indicates the following cases:

(c1) The driver causes the incorrect operation of the accelerator pedal 13 of the motor vehicle 10 after the driver executes the usual depression without causing any incorrect operation of the accelerator pedal 13;

(c2) The driver causes incorrect operation of the accelerator pedal 13 after the predetermined period of time is elapsed counted from the time when the driver causes the most recent incorrect operation of the accelerator pedal 13 of the motor vehicle 10; and

(c3) The driver causes the incorrect operation of the accelerator pedal 13 under the condition without causing any incorrect operation of the accelerator pedal 13 after the operation of the in-vehicle system 100 started.

The second-time occurrence of the incorrect operation in which the driver causes the incorrect operation of the accelerator pedal 13 for the second time indicates the following case:

(c4) The driver causes incorrect operation of the accelerator pedal 13 for the second time after the first-time occurrence of the first incorrect operation of the accelerator pedal 13, and the second-time occurrence of the incorrect operation of the accelerator pedal 13 is caused within the predetermined period of time counted from the time when the first-time occurrence of the incorrect operation is caused without the re-start of the in-vehicle system 100.

### (Second Case)

In the first exemplary embodiment previously described, the accelerator opening sensor 1 is equipped with the three ECUs corresponding to the collision reduction and escaping control device 7, the accelerator pedal incorrect operation judgment device 8 and the conflict control device 9, respectively. However, the concept of the present invention is not limited by this structure. For example, it is possible for the accelerator opening sensor 1 to have a single ECU which has the three functions composed of a collision reduction and escaping control part corresponding to the collision reduction and escaping control device 7, an accelerator pedal incorrect operation judgment part corresponding to the accelerator pedal incorrect operation judgment device 8, and a conflict control part corresponding to the conflict control device 9.

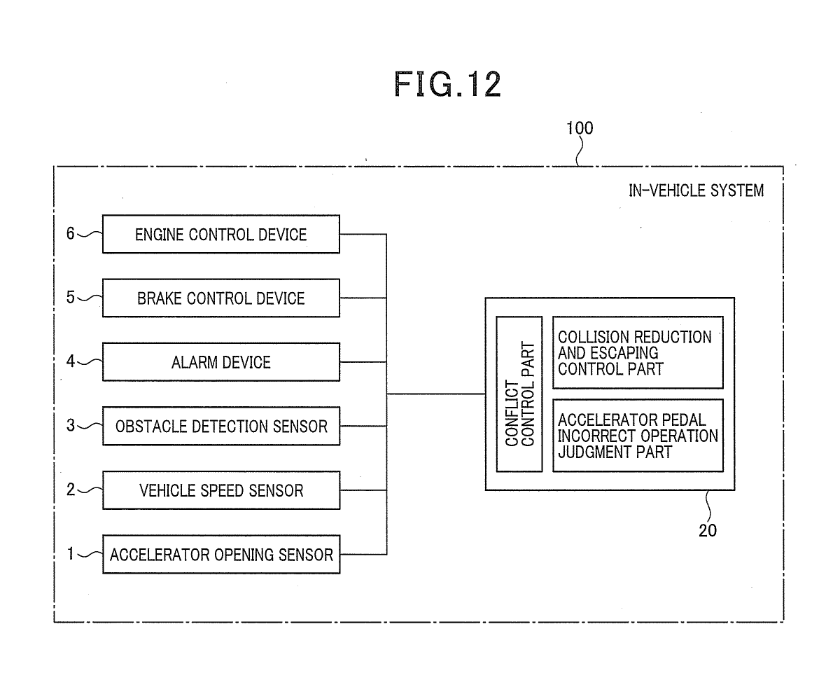

FIG. 12 is a view showing another structure of the in-vehicle system according to the present invention.

As shown in FIG. 12, the accelerator opening sensor 1 is equipped with the single ECU 20, and the CPU in the control device of the ECU 20 executed the program stored in the ROM in order to execute the process shown in FIG. 2, the process shown in FIG. 3 and the process shown in FIG. 4. In this case, the ECU 20 acts as the collision reduction and escaping control device 7 corresponding to the collision reduction and escaping control device 7 to execute the collision reduction and escaping control function shown in FIG. 2. Further, the ECU 20 acts as the accelerator pedal incorrect operation judgment part corresponding to the accelerator pedal incorrect operation judgment device 8 to execute the accelerator pedal incorrect operation detection function shown in FIG. 3. Still further, the ECU 20 acts as the conflict control part corresponding to the conflict control device 9 to execute the conflict control function shown in FIG. 4.

### (Third Case)

It is possible for the in-vehicle system 100 not to have the collision reduction and escaping control device 7. In this structure, it is sufficient for the conflict control device 9 to judge that the low speed PCS enable flag is always turned off in step S305. Still further, it is possible for the in-vehicle system 100 not to use the collision reduction and escaping control device 7 and the conflict control device 9. In this case, it is sufficient for the conflict control device 9 to execute the same control in step 230 shown in FIG. 3 and step S335 and step S340 shown in FIG. 4.

### (Fourth Case)

The first and second exemplary embodiments show the vehicle engine as the internal combustion engine to drive the motor vehicle 10. The concept of the present invention is not limited by this. For example, it is possible to apply the in-vehicle system 100 to an electric vehicle motor for driving an electric vehicle. In this case, the magnitude of the electric power to be supplied to the electric vehicle motor corresponds to the ratio of opening of the throttle valve. That is, the ratio of opening of the throttle valve and the electric power to be supplied to the electric motor are same in the view of the amount of energy to be supplied to the driving force generation engine.

### (Fifth Case)

The first and second exemplary embodiments show the predetermined function releasing operation in which the driver release his foot 12 from the accelerator pedal 13 in order to return the accelerator pedal 1 3 to its original position. The concept of the present invention is not limited by this. For example, it is possible for the driver to depress the brake pedal or to touch a dedicated functional releasing button instead.

### (Sixth Case)

The first and second exemplary embodiments, as previously described, show the cases in which the accelerator pedal incorrect operation judgment device 8 judges the occurrence of the driver's incorrect operation of the accelerator pedal 13 in step S220, and sets the accelerator pedal incorrect operation detection flag to be turned on in step S230. However, the concept of the present invention is not limited by this control. For example, it is possible for the accelerator pedal incorrect operation judgment device 8 to judge whether or not the accelerator pedal incorrect operation detection function is cancelled, and (d1) the accelerator pedal incorrect operation judgment device 8 sets the accelerator pedal incorrect operation detection flag to be turned on when the accelerator pedal incorrect operation detection function is not cancelled, and transmits the accelerator pedal incorrect operation detection flag of the turned-on state to the conflict control device 9; and (d2) the accelerator pedal incorrect operation judgment device 8 sets the accelerator pedal incorrect operation detection flag to be turned off when the accelerator pedal incorrect operation detection function is cancelled, and transmits the accelerator pedal incorrect operation detection flag of the turned-off state to the conflict control device 9.

The above control makes it possible to inhibit the execution of the incorrect operation measure assist function (step S335, step S340, step S345 and step S350).

A description will now be given of the cancelled state of the acceleration pedal incorrect operation detection.

When the main power source (IG) of the motor vehicle is turned on, the acceleration pedal incorrect operation detection function is working, not cancelled. The acceleration pedal incorrect operation detection is cancelled only when the driver depresses the accelerator pedal 13 within a predetermined period of time (for example, within 30 seconds) after the detection time when the incorrect operation of the accelerator pedal 13 is detected.

The following process is executed after the cancellation of the acceleration pedal incorrect operation detection is cancelled once. That is, the cancelled state of the acceleration pedal incorrect operation detection function is released, in other words, the acceleration pedal incorrect operation detection mode works or is enabled when the predetermined enable switch is operated and the main power source (IG) of the motor vehicle is switched from the turned-off state to the turned-on state after the predetermined period of time (for example, after 30 minutes) is elapsed counted from the time when the acceleration pedal incorrect operation detection is cancelled.

### (Seventh Case)

Still further, it is possible for the in-vehicle system 100 to have dedicated hardware (for example, a field programmable gate array (FPGA)) having the various functions. The various functions are realized when the CPU in the control device in each of the collision reduction and escaping control device 7, the accelerator pedal incorrect operation judgment device 8 and the conflict control device 9 executes the program stored in the ROM therein.

### (Features and Effects of the Present Invention)

As previously described in detail, the in-vehicle system 100 has the incorrect operation judgment means (for example, step S220) and the vehicle control means (for example, step S335, step S340, step S345 and step S350). The vehicle control means judges an occurrence of incorrect operation by the driver of the motor vehicle 10 to depress or deeply depress the accelerator pedal 13 of the motor vehicle 10, for example, at least one or many time. The vehicle control means controls a brake on movement of the motor vehicle on the basis of the judgment result of the incorrect operation judgment means which judges the occurrence of incorrect operation of the acceleration pedal 13. In particular, the vehicle control means allows a forward movement of the motor vehicle 10 within a predetermined period T1 of time. This predetermined period T1 of time is determined according to a predetermined movement distance after the judgment result to judge the occurrence of incorrect operation of the accelerator pedal 13. The vehicle control means increases a brake force to be generated in a brake control device 5 of the motor vehicle 10 in order to stop the forward movement of the motor vehicle 10 after the predetermined period T1 of time is elapsed.

The in-vehicle system 100 allows the motor vehicle 10 to move in the forward direction during the predetermined period T1 of time which is determined according to the predetermined movement distance of the motor vehicle 10 counted from the time when the driver of the motor vehicle 10 causes incorrect operation of the accelerator pedal 13, and the in-vehicle system 100 stops the movement of the motor vehicle 10 after the elapse of the predetermined period T1 of time. In this case, when the motor vehicle 10 enters in a dangerous area such as the inside of a railroad crossing, even if the driver is confused and the driver causes incorrect operation of the accelerator pedal, the motor vehicle 10 can slightly move toward in the forward direction and then is stopped. This makes it possible to prevent the motor vehicle 10 from sudden starting or from causing quick acceleration when the driver causes such incorrect operation of the accelerator pedal 13 of the motor vehicle 10. Still further, even if the driver repeatedly causes such incorrect operation of the accelerator pedal 13 of the motor vehicle 10, which is different from the usual depression, in order to escape from the dangerous area (from the inside of a railroad crossing), it is possible for the in-vehicle system 100 and the driver to move the motor vehicle 10 from the dangerous area.

The in-vehicle system 100 further has an obstacle escaping means (for example, step S320, step S325 and step S330). The obstacle escaping means inhibits a start of the motor vehicle at the time when an obstacle is detected within a predetermined brake start distance on the basis of the fact in which the obstacle is present within the predetermined brake start distance in the forward direction of the movement of the motor vehicle 10. Further, the obstacle escaping means releases the inhibition to start the movement of the motor vehicle 10 on the basis of executing a predetermined function releasing operation.

The obstacle escaping means works when the motor vehicle 10 equipped with the in-vehicle system 100 is present behind an obstacle. The vehicle control means works when the driver causes incorrect operation of the accelerator pedal 13 of the motor vehicle 10. When the in-vehicle system 100 has both obstacle escaping means and the vehicle control means, the obstacle escaping means inhibits the forward movement of the motor vehicle 10 when the obstacle escaping means is working. On the other hand, the vehicle control means allows the motor vehicle 10 to move forward during the predetermined period T1 of time after the occurrence of incorrect operation of the accelerator pedal 13 of the motor vehicle 10. Further, the vehicle control means stops the movement of the motor vehicle 10 after the predetermined period T1 of time is elapsed. That is, the both means execute the different functions. Therefore the driver can distinguish both the functions, the obstacle escaping function and the vehicle control function (as the incorrect operation measure assistance function), namely, can recognize which function is currently working.

If both the functions show the same motion and operation and the driver of the motor vehicle 10 cannot distinct them correctly, there is a strong possibility of confusing the driver into the following state. When the motor vehicle 10 is stopped and the obstacle escaping function is now enabled or working, the driver causes incorrect operation of the accelerator pedal 13 of the motor vehicle 10 after the driver releases the obstacle escaping function. In this situation, the vehicle control function (as the incorrect operation measure assistance function) is enabled and the enabled state thereof inhibits the movement of the motor vehicle, like the execution of the obstacle escaping function. The driver misunderstands that the obstacle escaping function is now working although the driver has already released the obstacle escaping function. The driver is thereby confused.

The in-vehicle system 100 according to the present invention further has a conflict control device (for example, step S305, step S310 and step S315). The conflict control device uses the vehicle control means instead of the obstacle escaping means when there is an obstacle within the predetermined brake start distance and the incorrect operation of the accelerator pedal 13 of the motor vehicle 10 is occurred.

This configuration of the in-vehicle system 100 makes it possible to provide to the driver the information regarding the occurrence of incorrect operation of the accelerator pedal 13. This can invite the driver to execute the usual depression to the accelerator pedal as soon as possible.

In the in-vehicle system 100, within the predetermined period T1 of time, the vehicle control means provides the minimum brake force to the brake control device 5 of the motor vehicle 10 and decreases the amount of energy to be supplied to a drive force generating device according to the time elapsed. This structure of the in-vehicle system 100 makes it possible to avoid the motor vehicle 10 from performing quick acceleration or sudden starting during the predetermined period T1 of time.

In the in-vehicle system 100, the vehicle control means immediately inhibits the movement of the motor vehicle 10 when the driver causes incorrect operation of the accelerator pedal 13 of the motor vehicle 10 after the predetermined period T1 of time is elapsed counted from the occurrence of the most recent incorrect operation, or when the driver causes incorrect operation of the accelerator pedal 13 under the condition without any incorrect operation of the accelerator pedal 13 of the motor vehicle 10 after the in-vehicle system starts to work. The vehicle control means provides the minimum brake force to the brake control device 5 in order to allow the motor vehicle 10 to move in the forward direction during the predetermined period T1 of time counted from the time when new incorrect operation of the accelerator pedal 13 occurs within a predetermined period of time counted from the time when the most recent incorrect operation of the accelerator pedal 13 of the motor vehicle 10 is caused. The vehicle control means increases the brake force, from the minimum value, to be generated in the brake control device 5 of the motor vehicle 10 and then stops the motor vehicle 10.

When the driver of the motor vehicle 10 causes incorrect operation of the accelerator pedal 13 in which the driver strongly or deeply depress the accelerator pedal 13 plural times, there is a strong possibility that the driver is confused and the driver intends to try the motor vehicle 10 to move toward in the forward direction in order to escape from the dangerous area such as from the inside of a railroad crossing. The in-vehicle system 100 detects the driver's incorrect operation and controls the motor vehicle 10 to slightly move and then to stop completely. However, when the in-vehicle system 100 detects the first incorrect operation of the accelerator pedal 13, the in-vehicle system 100 stops the motor vehicle 10 immediately in the view of safety. This can assist the safety drive of the motor vehicle 10.

In the in-vehicle system 100, the function of the vehicle control means is inhibited on the basis of detecting the incorrect operation of the accelerator pedal 13 of the motor vehicle 10 after the vehicle control means judges that the driver's incorrect operation of the accelerator pedal 13 is occurred. This structure of the in-vehicle system 100 makes it possible to cancel the function of the vehicle control means when the driver executes the brake operation.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An in-vehicle system comprising:
an incorrect operation judgment means for judging an occurrence of incorrect operation by a driver of a motor vehicle to depress an accelerator pedal of the motor vehicle at least one or many time; and
a vehicle control means for controlling a brake force of the motor vehicle on the basis of the judgment result of the incorrect operation judgment means when the incorrect operation of the acceleration pedal is occurred, the vehicle control means allowing a forward movement of the motor vehicle during a predetermined period of time, which is set in advance according to a predetermined movement distance, after the time of detecting the occurrence of the incorrect operation of the accelerator pedal, the vehicle control means increasing a brake force generated in a brake control device of the motor vehicle in order to stop the forward movement of the motor vehicle after the predetermined period of time is elapsed.

2. The in-vehicle system according to claim 1, further comprising an obstacle escaping means for inhibiting a start of the forward movement of the motor vehicle at the time when an obstacle is detected within a predetermined brake start distance in the forward direction of the movement of the motor vehicle on the basis of the fact in which the obstacle is present within the predetermined brake start distance, and for releasing the inhibition to start the movement of the motor vehicle on the basis of executing a predetermined function releasing operation.

3. The in-vehicle system according to claim 2, further comprising a conflict control device for using the vehicle control means rather instead of the obstacle escaping means when there is an obstacle within the predetermined brake start distance and the incorrect operation of the accelerator pedal of the motor vehicle is occurred.

4. The in-vehicle system according to claim 1, wherein within the predetermined period of time, the vehicle control means provides the minimum brake force to the brake control device of the motor vehicle and decreases the amount of energy to be supplied to a drive force generating device according to the time elapsed.

5. The in-vehicle system according to claim 1, wherein
the vehicle control means immediately inhibits the movement of the motor vehicle when the driver causes the incorrect operation of the accelerator pedal after the predetermined period of time is elapsed counted from the occurrence of a most recent incorrect operation, or when the driver causes the incorrect operation of the accelerator pedal under the condition without any incorrect operation after the in-vehicle system starts to work, and
the vehicle control means provides the minimum brake force to the brake control device in order to allow the motor vehicle to move in the forward direction during the predetermined period of time counted from the time when new incorrect operation of the accelerator pedal occurs within a predetermined period of time counted from the time when the driver causes the most recent incorrect operation of the accelerator pedal, and
the vehicle control means increases the brake force, from the minimum value, to be generated in the brake control device of the motor vehicle, and stops the motor vehicle.

6. The in-vehicle system according to claim 1, wherein the function of the vehicle control means is stopped on the basis of the detection of the incorrect operation of the accelerator pedal of the motor vehicle after the vehicle control means judges that the incorrect operation of the accelerator pedal has occurred.

7. The in-vehicle system according to claim 3, wherein each of the obstacle escaping means, the incorrect operation judgment means and the conflict control device is composed of an electric control unit.

8. The in-vehicle system according to claim 3, wherein the entire of the obstacle escaping means, the incorrect operation judgment means and the conflict control device is composed of an electric control unit.
